(19) United States
(12) Patent Application Publication
(10) Pub. No.: US 2009/0302193 A1
(43) Pub. Date: Dec. 10, 2009

(54) MOLD CORE WITH DEPOSITION ISLANDS AND METHOD FOR MANUFACTURING THE SAME

(75) Inventor: HSIN-HUNG CHUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/255,541

(22) Filed: Oct. 21, 2008

(30) Foreign Application Priority Data
Jun. 4, 2008 (CN) 200810302007.3

(51) Int. Cl. B28B 7/28; B44C 1/22

(52) U.S. Cl. 249/175; 216/11

(57) ABSTRACT

A mold core includes a substrate, rounded deposition islands distributed on the substrate, and molding layer portions formed on the deposition islands. Each of the molding layer portions encloses a corresponding deposition island.

### BACKGROUND

1. Technical Field

The present invention relates to a mold core typically used for making lenses and a method for manufacturing the mold core.

2. Discussion of Related Art

Products such as optical lenses are critical components in apparatuses such as camera devices. Optical lenses are typically fabricated by injection molding or by a hot embossing process. However, it is very difficult to manufacture a mold suitable for performing injection molding and hot embossing of microlenses because of the small size required. Many methods have been developed to fabricate microlenses, such as photoresist thermal reflow, polymethylmethacrylate (PMMA) expanding-shrinking, dripping, and a gray scale mask process. However, the efficiency of these methods is typically low and the cost is high.

Therefore, a new mold core and method for manufacturing a mold core are desired to overcome the above-described problems.

### SUMMARY

A mold core includes a substrate, a plurality of deposition islands distributed on the substrate, and a plurality of molding portions formed on the deposition islands. Each of the molding portions covers a corresponding deposition island.

Other aspects, features and advantages of embodiments of a mold core and a method for manufacturing the mold core in accordance with the present invention will become apparent from the following detailed description and the drawings.

### BRIEF DESCRIPTION OF THE DRAWINGS

The components in the drawings are not necessarily drawn to scale, the emphasis instead being placed upon clearly illustrating the principles of the present invention.

FIG. 1 is a flow chart illustrating an embodiment of a method for manufacturing a mold.

FIGS. 2-11 are cross-sectional views showing successive steps of fabricating a mold core according to the method of FIG. 1.

### DETAILED DESCRIPTION OF THE EMBODIMENTS

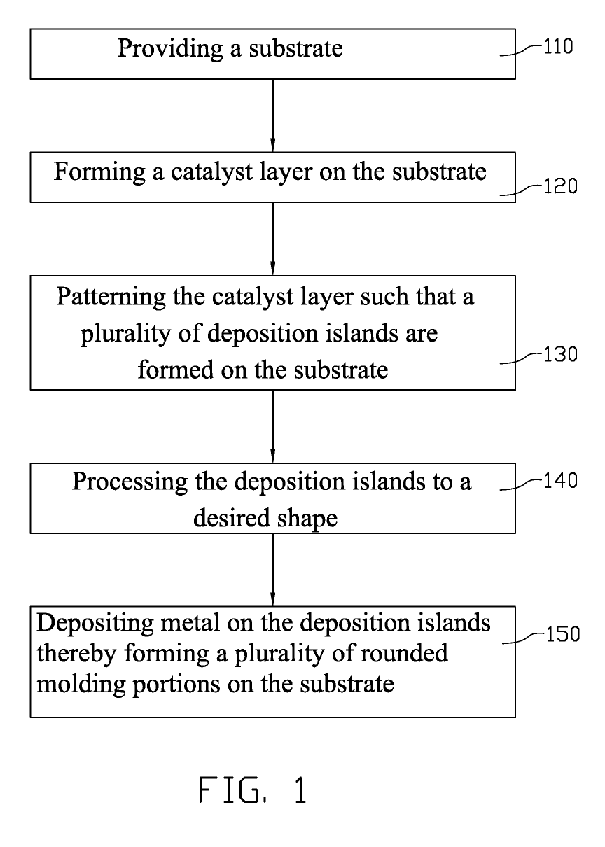

FIG. 1 is a flowchart illustrating an embodiment of a method for manufacturing a mold core. Depending on the embodiment, certain of the blocks described below may be removed, others may be added, and the sequence of blocks may be altered.

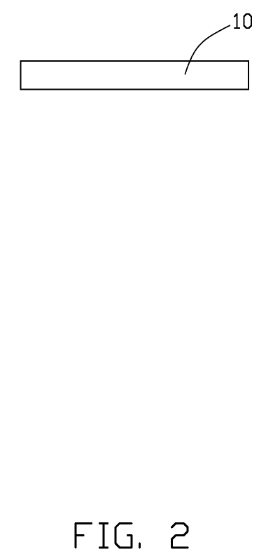

FIGS. 2-11 schematically show successive steps of fabricating a mold core according to an embodiment of the method of FIG. 1. In a block 110, referring to FIG. 2, a substrate 10 is provided. The substrate 10, for example, has a thickness from about 20 micrometers to about 500 micrometers and a diameter from about 100 millimeters to about 300 millimeters. The substrate 10 is catalytically inert to an electroless plating reaction, so that when the substrate 10 is immersed in an electroless plating bath, there are no metal particles deposited on a surface of the substrate 10. For example, when manufacturing a nickel mold core, the substrate 10 should be catalytically inert to the electroless plating reaction of nickel. In the present embodiment, the substrate 10 is a silicon wafer. Typically, the substrate 10 is cleaned to improve a quality of the obtained mold core. For example, the substrate 10 can be cleaned by dry cleaning or vapor cleaning processes, or micro etched using a chemical solution.

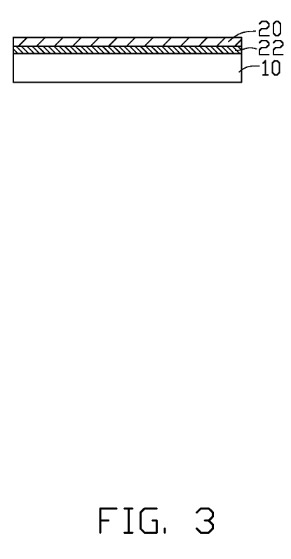

Continuing to a block 120, referring to FIG. 3, a catalyst layer 20 is formed on the substrate 10. In the present embodiment, the catalyst layer 20 is a nickel plating layer. The catalyst layer 20 can be formed using an e-beam evaporation method or by sputtering, for example. The catalyst layer 20 has a thickness from about 0.5 micrometers to about 10 micrometers. In one embodiment, an intermediate layer 22 is formed on the substrate 10 prior to formation of the catalyst layer 20 to improve an adhesion force between the catalyst layer 20 and the substrate 10. The intermediate layer 22 has a thickness from about 0.1 micrometers to about 5 micrometers. In the present embodiment, the intermediate layer 22 is a chromium plating layer having a thickness of about 0.2 micrometers.

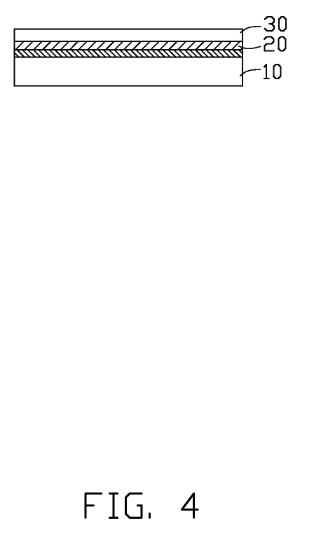

Moving to a block 130, the catalyst layer 20 is patterned such that a number of deposition islands 24 are formed on the substrate 10. In the present embodiment, the catalyst layer 20 is patterned using a lithography method. As shown in FIG. 4, a photoresist layer 30 is formed on the catalyst layer 20. In the present embodiment, the photoresist layer 30 is made of negative photoresist. The volatilization process of the solvent in the photoresist layer 30 can be accelerated by soft baking the substrate 10 with the photoresist layer 30 applied thereon, using a hot plate at 90-100° C. about 1 minute.

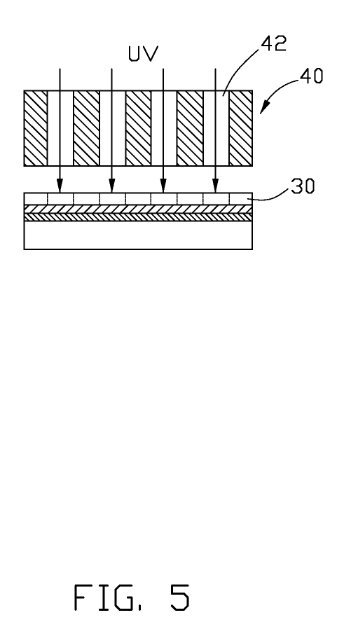

After the photoresist layer 30 is applied on the catalyst layer 20, referring to FIG. 5, a photo mask 40 having a number of separated through holes 42 is positioned above the photoresist layer 30. Portions of the photoresist layer 30 are exposed by the through holes 42. The photoresist layer 30 is irradiated by a light source (not shown) causing the polymer in the photoresist layer 30 to crosslink because the photoresist is a negative photoresist. In the present embodiment, ultraviolet (UV) light is used to improve exposure resolution. The UV light passes through the through holes 42 and reacts with the photoresist layer 30. In the present embodiment, the through holes 42 may be circular or elliptical. In other embodiments, the through holes 42 may be rectangular (e.g. square).

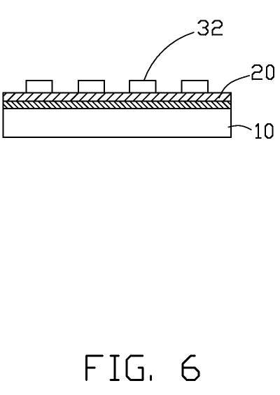

The unexposed portions of the photoresist layer 30 are developed using a developing solution. Referring to FIG. 6, because the photoresist is a negative photoresist, the unexposed portions of the photoresist layer 30 are removed, thereby forming a number of separated photoresist blocks 32 on a surface of the catalyst layer 20. After the photoresist blocks 32 are formed, a hard baking step is performed on the photoresist blocks 32 by placing the substrate 10 on a hot plate having a temperature of about 120° C. for about 2 minutes. After the hard baking is completed, the resin in the photoresist blocks 32 is fully cured making the photoresist blocks 32 more corrosion resistant.

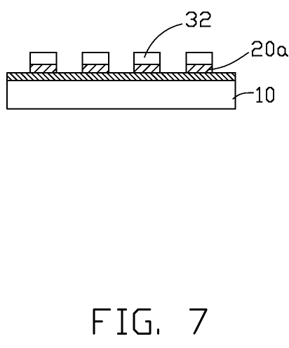

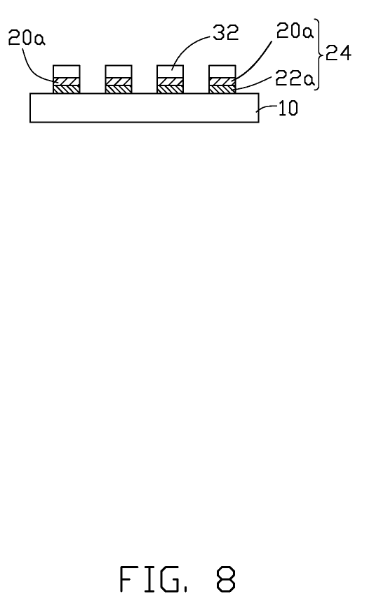

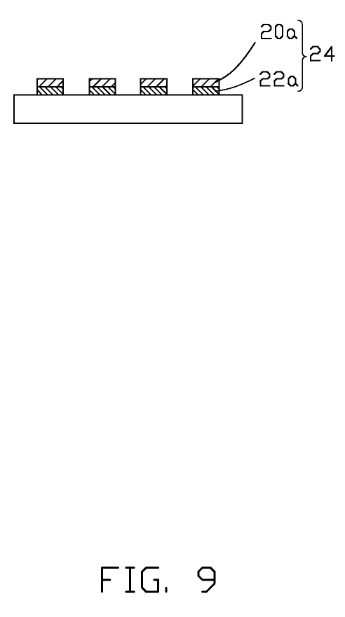

Referring to FIGS. 7 and 8, the catalyst layer 20 and the intermediate layer 22 are etched using etchants that react with portions of the catalyst layer 20 and the intermediate layer 22 not covered by the photoresist blocks 32, to form a plurality of block-shaped deposition islands 24 Each block-shaped deposition island 24 comprises a catalyst island layer 20a and an intermediate island layer 22a. The deposition islands 24 are separated from each other. In the present embodiment, the block-shaped deposition islands 24 may be cylindrical or generally elliptical. In other embodiments, the block-shaped deposition islands 24 may be generally cuboid or box-shaped. As shown in FIG. 9, the photoresist blocks 32 are removed using a stripping solvent such as acetone. Thus, the block-shaped deposition islands 24 are formed using a lithography method.

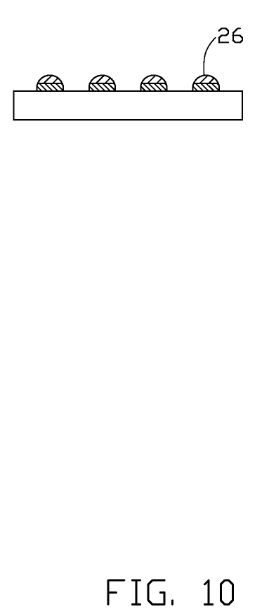

Continuing to a block 140, referring to FIG. 10, the block-shaped deposition islands 24 are processed to a desired shape by a desired method. For example, a laser, an ion beam, or an electron beam can be used to shape the block-shaped deposition islands 24 to obtain a desired shape (e.g. dome-topped, domelike, dome-shaped, spherical, aspherical, hemispherical, cone shaped, or conical frustum shaped). In the present embodiment, the block-shaped deposition islands 24 are processed to become rounded (or curved) deposition islands 26. In the illustrated embodiment, each of the rounded deposition islands 26 has an arch-shaped cross-section. In other embodiments, each of the rounded deposition islands 26 may have an arc-shaped cross-section or a dome-shaped cross-section.

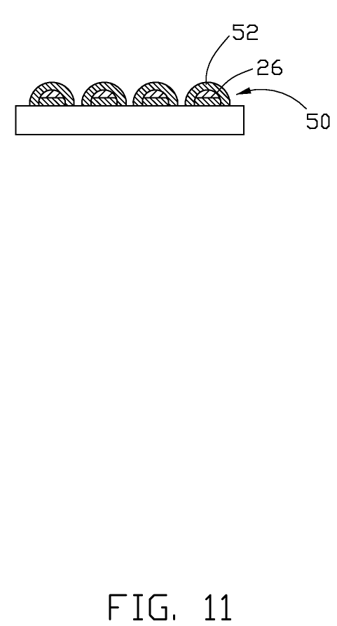

Moving to a block 150, referring to FIG. 11, a metal layer 52 is deposited on each of the rounded deposition islands 26 thereby forming a plurality of rounded molding portions 50. Each of the metal layers 50 encloses a corresponding rounded deposition island 26. The molding portions 50 are separated from each other. The molding portions 50 may be dome-topped, domelike, dome-shaped, spherical, aspherical, or hemispherical, for example. In the illustrated embodiment, each of the molding portions 50 has an arch-shaped cross-section. In other embodiments, each of the molding portions 50 may instead have an arc-shaped cross-section or a dome-shaped cross-section.

In the present embodiment, the metal layer is deposited using an electroless plating method. In the electroless plating process, the self-catalyzing activity of the catalyst layer 20 causes metal particles to be continuously produced and deposited on surfaces of the deposition islands 22 until the molding portions 50 are obtained. Thus the shape of the rounded deposition islands 26 can affect the shape of the molding portions 50. For example, a spherical rounded deposition island 26 is advantageously suitable for forming a spherical molding portion 50, while an aspherical rounded deposition island 24 is advantageously suitable for forming an aspherical molding portion 50. Because metal particles are only deposited on surfaces of the rounded deposition islands 26 and the rounded deposition islands 26 are separate from each other, when a deposition time is controlled, the molding portions 50 are also separate from each other.

A hard coating, such as a silicon carbide (SiC) coating or a diamond-like carbon (DLC) coating, may be formed on surfaces of the molding portions 50 using a sputtering method to improve the hardness of the molding portions 50.

The mold core includes the substrate 10, and the plurality of molding portions 50. Each of the molding portions 50 mimics the shape of the corresponding rounded deposition island 26. The molding portions 50 are separate from each other.

The present embodiment uses the lithography method and the electroless plating method to manufacture the mold core. Due to the high resolution and low cost of the lithography method, the mold core can be inexpensively manufactured and still have high precision. In one embodiment, the mold core can be directly used in a mold to manufacture concave lenses. In another embodiment, the mold core can be used as a “negative” to fabricate another complementary mold core having a plurality of depressions corresponding to the molding portions 50. The complementary mold core is then used in a mold to manufacture convex lenses. In either case, the mold can manufacture a large batch of high-precision lenses in a single mold cycle. Typically, the lenses of interest are microlenses. Thereby, the efficiency of microlens fabrication is improved, and the cost of the microlens fabrication is correspondingly reduced.

It is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for manufacturing a mold core, comprising:
providing a substrate;
forming a catalyst layer over the substrate;
patterning the catalyst layer such that a plurality of deposition islands are formed on the substrate, wherein the deposition islands are separate from each other;
depositing a metal layer on surfaces of the deposition islands to form a plurality of molding portions on the substrate.

2. The method of claim 1, wherein the catalyst layer is formed by depositing a nickel plating layer on the substrate.

3. The method of claim 2, further comprising forming an intermediate layer on the substrate prior to forming the catalyst layer over the substrate, wherein the intermediate layer provides adhesion between the catalyst layer and the substrate.

4. The method of claim 1, wherein the catalyst layer is patterned using a lithography method.

5. The method of claim 4, wherein patterning the catalyst layer comprises forming a photoresist layer on the catalyst layer, irradiating portions of a surface of the photoresist layer with a light source to form a photoresist pattern, and etching the catalyst layer according to the photoresist pattern.

6. The method of claim 5, wherein the irradiating is performed using a photo mask to shield other portions of the surface of the catalyst layer; the light source being an ultraviolet light source.

7. The method of claim 1, wherein the plurality of deposition islands formed on the substrate are selected from the group consisting of block-shaped, cylindrical, generally elliptical, generally cuboid, and box-shaped.

8. The method of claim 7, further comprising processing the plurality of deposition islands such that the deposition islands become rounded, prior to depositing the metal layer on the surfaces of the deposition islands.

9. The method of claim 8, wherein processing the plurality of deposition islands such that the deposition islands become rounded is performed using at least one item selected from the group consisting of a laser, an ion beam, and an electron beam.

10. The method of claim 8, wherein the rounded deposition islands are selected from the group consisting of dome-topped, domelike, dome-shaped, spherical, hemispherical, and aspherical.

11. The method of claim 8, further comprising forming a hard coating on each of the metal layers.

12. A mold core, comprising:
a substrate;
a plurality of rounded deposition islands formed on the substrate; and
a plurality of molding layer portions formed on the deposition islands, wherein each of the molding layer portions encloses a corresponding deposition island, and the molding layer portions are separate from each other.

13. The mold core of claim 12, wherein the substrate is made of silicon.

14. The mold core of claim 13, wherein a thickness of the substrate is in the range from about 20 micrometers to about 500 micrometers.

15. The mold core of claim 12, wherein each of the deposition islands comprises a metal layer.

16. The mold core of claim 15, wherein each of the deposition islands further comprises an intermediate layer between the metal layer and the substrate, and the intermediate layer has a thickness in the range from about 0.1 micrometers to about 5 micrometers.

17. The mold core of claim 16, wherein the metal layer is a nickel plating layer, and the intermediate layer is a chromium plating layer having a thickness of about 0.2 micrometers.

18. The mold core of claim 12, wherein the deposition islands are selected from the group consisting of dome-topped, domelike, dome-shaped, spherical, aspherical, and hemispherical.

19. The mold core of claim 12, further comprising a hard coating formed on a surface of each of the molding layer portions.

20. The mold core of claim 19, wherein the hard coating is selected from the group consisting of a silicon carbide coating and a diamond like carbon coating.
